(19) United States
(12) Patent Application Publication
(10) Pub. No.: US 2010/0194688 A1
(43) Pub. Date: Aug. 5, 2010

(54) Information processing apparatus

(76) Inventor: Jaewoo Shim, Seongnam-si (KR)

Correspondence Address: Kirk Hermann, 150 Cerro Vista Way, Anaheim, CA, 92807, US

(21) Appl. No.: 12/454,103

(22) Filed: May 12, 2009

(30) Foreign Application Priority Data
Feb. 4, 2009 (KR) 10-2009-8977

(51) Int. Cl. G06F 3/041; G06F 3/033

(52) U.S. Cl. 345/163; 345/173

(57) ABSTRACT

An information processing apparatus including a sensing unit that functions as a mouse, the apparatus including a main body with a key input device; a sensing unit installed in one side of the key input device and detecting the user's operation to adjust a position of a mouse pointer on a display; and a pad disposed on the upper side of the sensing unit and movable to change the position of the mouse pointer on the display, thereby providing a user with the prompt and easy manipulation of the mouse pointer.

### BACKGROUND OF THE INVENTION

This application claims the benefit under 35 U.S.C. §119(a) of a Korean patent application filed in the Korean Intellectual Property Office on Feb. 4, 2009 and assigned Serial No. 10-2009-8977, the entire disclosure of which is hereby incorporated by reference.

### BACKGROUND OF THE INVENTION

1. Field of the Invention

The present invention relates to an information processing apparatus, and more particularly to, an information processing apparatus including a sensing unit that detects a user's motion to adjust a position of a mouse pointer on a display and a movable pad that is disposed on the upper side of the sensing unit so as to change the position of the mouse pointer on the display, which provides the easy manipulation of the mouse pointer and requires no external mouse.

2. Description of the Related Art

General information processing apparatuses, such as personal computers, notebook computers, word processors, and communication terminals, are designed to have a mouse installed therein so as to promote the user's convenience when a position needs to be changed on an information document which is being prepared, edited and read. Information processing apparatuses in which the mouse is installed allow the easy change of a position on the information document as desired by the corresponding user by moving a mouse pointer on a display by a distance that the mouse moves.

In particular, notebook computers, for which a demand has increased owing to their mobility, have a touchpad installed therein as a device for moving appearance, and a light touch with the finger is the same as a click of a left button of an external mouse and thus users can use the notebook computers without an installed click button installed on the touchpad.

However, when the finger touches the touchpad to move the mouse pointer, a click of the touchpad is automatically performed due to discontinuous contact with the finger, which caused an error. Further, when dragging is performed with the mouse pointer, the finger moves above the touchpad and another finger must press a fixed click button, which also causes user's inconvenience. Touching and no touching of a finger can be performed on the touchpad several times to move the mouse pointer due to a small area of the touch pad, which makes it difficult to move the mouse pointer as compared to the external mouse, and thus the speed of computer usage becomes slower.

Thus, there are many cases when a user carries a general external mouse when using a notebook computer. However, the user frequently needs to move the notebook computer itself, which provides the user with inconvenience in connecting the external mouse to a connection terminal of the notebook computer and in additionally carrying the external mouse when not in use.

### SUMMARY OF THE INVENTION

1. Target Problem to be Solved

The present invention provides an information processing apparatus including a sensing unit that detects a user's motion to adjust a position of a mouse pointer on a display and a movable pad that is disposed on the upper side of the sensing unit so as to change the position of the mouse pointer on the display, which provides the easy manipulation of the mouse pointer and a user's convenience as if an external mouse was being used without additionally carrying the external mouse.

1. Problem Solving Method

According to an aspect of the present invention, there is provided an information processing apparatus comprising: a main body including a key input device; a sensing unit installed in one side of the key input device and detecting a user's operation to adjust a position of a mouse pointer on a display; and a pad disposed on the upper side of the sensing unit and movable to change the position of the mouse pointer on the display.

At least one of the key input device and the main body may comprise a position adjustment button that allows the mouse pointer to be positioned on the center of the display when the center portion of the pad is positioned in the upper side of the sensing unit.

At least one of the key input device and the main body may comprise a click button used to designate the position of the mouse pointer.

At least one of the key input device and the main body may comprise a scroll member that is used to change a position in an information document that is being read.

The sensing unit may be integrally installed in the main body.

The main body may comprise a groove portion in the upper side of the sensing unit, the groove portion comprises an entrance portion in contact with exterior and inside portion formed to be greater than the radius of the entrance portion and curved inside the groove portion, hence the pad is inserted into the inside portion and is movably installed.

The inside portion may comprise a portion sensor that allows the mouse pointer to be positioned on the boundary of the display when the pad contacts the exterior circumferential surface of the inside portion.

A plurality of the position sensors may be installed in the exterior circumferential surface of the inside portion so that the mouse pointer is positioned on the boundary of the display corresponding to the position of the position sensor.

The sensing unit may comprise an optical sensor including a light emitting sensor and a light receiving sensor for detecting the movement of the pad.

1. Expected Result

An information processing apparatus of the present invention includes a sensing unit that detects the user's motion to adjust a position of a mouse pointer on a display and a movable pad that is disposed on the upper side of the sensing unit so as to change the position of the mouse pointer on the display, thereby providing a user with the easy manipulation of the mouse pointer.

In addition, the sensing unit and the pad are integrally included in a main body, which does require an additional external mouse.

### DETAILED DESCRIPTION OF THE INVENTION

The present invention provides an information processing apparatus that includes a main body including a key input device, a sensing unit that detects a user's motion to adjust a position of a mouse pointer on a display, and a movable pad that is disposed on the upper side of the sensing unit so as to change the position of the mouse pointer on the display.

Hereinafter, the exemplary embodiments of the present invention will be described more fully with reference to the accompanying drawings. However, the embodiments may, however, be embodied in many different forms and should not be construed as being limited to the embodiments set forth herein; rather, these embodiments are provided so that this disclosure will be thorough and complete, and will fully convey the concept of the invention to those of ordinary skill in the art.

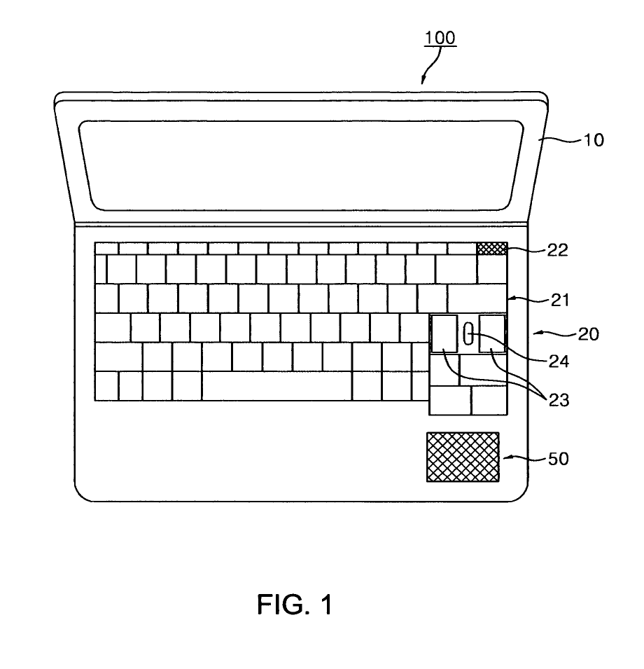

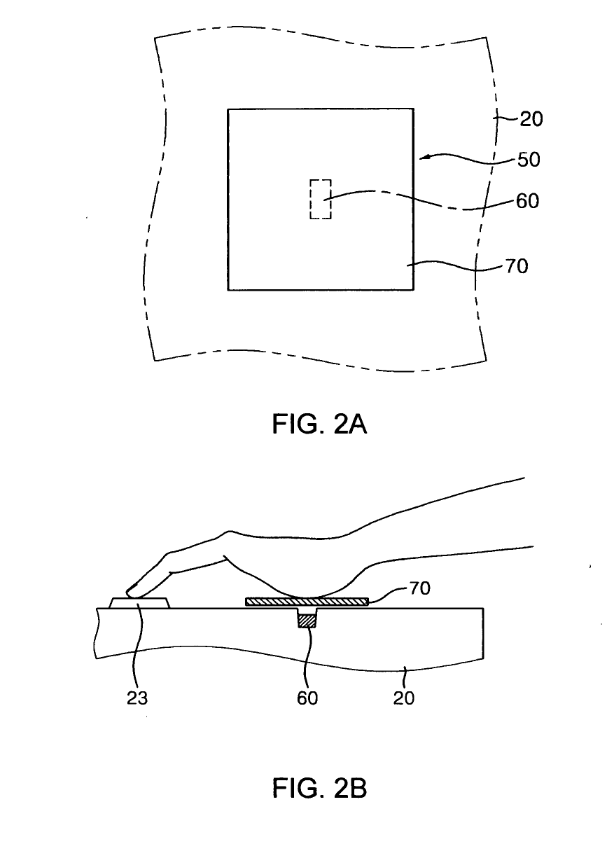

FIG. 1 is a perspective view of an information processing apparatus 100 according to an embodiment of the present invention. FIG. 2A is a plan view of a sensing unit 60 according to an embodiment of the present invention. FIG. 2B illustrates a pad operation status in which a finger is used according to the sensing unit 60 shown in FIG. 2A. FIG. 2C illustrates another pad operation status in which the finger is used according to the sensing unit 60 shown in FIG. 2A.

The information processing apparatus 100 performs a predetermined operation according to a user's instruction or command, and include an electric calculator, a mobile communication terminal, a computer, and the like. In particular, the computer is being changed into a notebook computer owing to its mobility.

Referring to FIGS. 1 through 2C, the information processing apparatus 100 of the present embodiment, in particular, a notebook computer 100, includes a display 10 that allows a user's visible recognition and a main body 20 that is connected to the display 10 and performs an operation. The main body 20 includes a key input device 21 for receiving a signal from a user. The key input device 21 includes a plurality of buttons used to input a user's predetermined instruction or data in the American Standard Code for Information Interchargecode (ASCII) code. The notebook computer 100 may include a signal input member 50, such as a mouse, so as to promote user's convenience when a position needs to be changed on an information document which is being prepared, edited, or read. The signal input member 50 makes it possible to easily change a position on the information document as desired by the user by moving a mouse pointer on the display 10.

In particular, when the signal input member 50 is used to input a signal, a device is required for adjusting the position of the mouse pointer on the display 10. To this end, the sensing unit 60 that detects a user's motion may be disposed in one side of the key input device 21.

A pad 70 that is movable up and down left and right so as to change the position of the mouse pointer on the display 10 may be disposed in an upper side of the sensing unit 60.

When the user detects a movement of the pad 70 through the sensing unit 60, the main body 220 may include a controller (not shown) that displays the position of the mouse pointer on the display 10 in response to the movement of the pad 70.

The pad 70 may be installed in the information processing apparatus 100, in particular, the notebook computer, or may be carried with the user. When the user uses the notebook computer 100, the user may use his/her palm or finger, such as a thumb, to move the pad up and down left and right from the upper side of the sensing unit 60, thereby easily manipulating the position of the mouse pointer.

In this regard, an upper side surface of the pad 70 needs to be formed of a less slippery material with finger or the palm and a lower side surface thereof needs to be formed of a freely slippery material from the upper side of the sensing unit 60. The material of the pad 70 may be suitably used to maintain a predetermined shape. Also, the pad 70 may be attached to the palm or the finger or may be put on the palm or the finger in the form of a glove.

At least one of the key input device 21 and the main body 20 may include a position adjustment button 22 used to adjust the position of the mouse pointer to the center of the display 10 when the center portion of the pad 70 is positioned on the upper side of the sensing unit 60. The position adjustment button 22 may include a simple function key disposed on the key input device 21. Thus, the position adjustment button 22 can be used to simply adjust the position of the mouse pointer when it is necessary to adjust the position of the mouse pointer while the user is currently using the notebook computer 100 or after the user has completely used the notebook computer 100.

At least one of the key input device 21 and the main body 20 may include two click buttons 23 used to designate the position of the mouse pointer. The click buttons 23 have the same function as the left and right buttons of a generally used external 3-button mouse. In more detail, if the user inputs a signal through the click buttons 23, an operating system (OS) of a system recognizes a user select signal and sends a message of the recognized signal to an application program. The click buttons 23 may be sufficiently lengthy in order to accommodate all hand sizes and finger lengths. In this regard, when the palm is used to move the pad 70, the click buttons 23 may be included in the key input device 21, and when the finger, in particular, the thumb, is used to move the pad 70, the click buttons 23 may be included in a bottom portion or a main body of the key input device 21 according to the user's convenience.

At least one of the key input device 21 and the main body 20 may include a scroll member 24 used to change the position of the information document that is being read.

The scroll member 24 may employ a scroll wheel, slide, or button method so as to change the position in the information document that is being read. In particular, the scroll wheel has the same function as a scroll wheel of the generally used external 3-button mouse. In more detail, when the scroll member is rotated, the scroll wheel performs a function of moving the information document on the display 10 up and down. The scroll wheel 24 may be formed in a single module or may be disposed between the click buttons 23 like the general external mouse.

Meanwhile, the sensing unit 60 may be integrally formed with the main body 20. In more detail, the sensing unit 60 may be integrally formed with the main body 20 in one side of the key input device 21. The sensing unit 60 is formed in one side of the main body 20 and the pad 70 is used to adjust the position of the mouse pointer on the display 10, which prevents the inconvenience of additionally carrying a mouse.

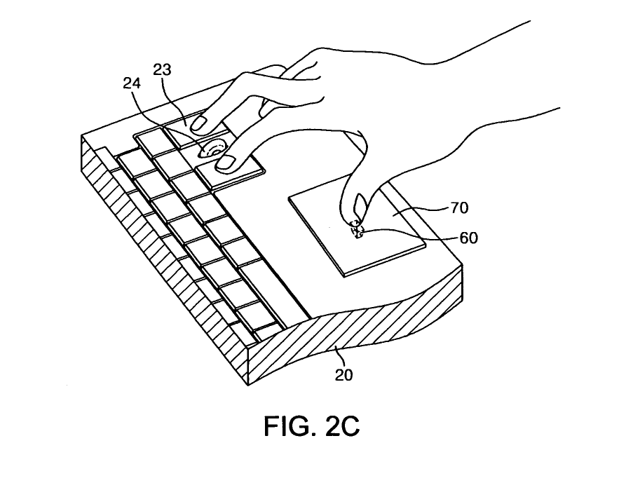

FIG. 3A is a plan view of a sensing unit 60 according to another embodiment of the present invention. FIG. 3B illustrates a pad operation status in which a finger is used according to the sensing unit 60 shown in FIG. 3A. FIG. 3C illustrates another pad operation status in which a finger is used according to the sensing unit 60 shown in FIG. 3A.

Referring to FIGS. 3A through 3C, the main body 20 may include a groove portion 30 in the upper side of the sensing unit 60. The groove portion 30 includes an entrance portion 31 that contacts the exterior and an inside portion 32 that is formed to be greater than a radius of the entrance portion 31 and is curved inside thereof.

The pad 70 is inserted into the inside portion 32 and may be movable up and down and left and right within the inside portion 32. The pad 70 is inserted into the inside portion 32. The sensing unit 60 detects any up and down and left and right movements of the pad 70 that are performed by a user. Therefore, the position of the mouse pointer on the display 10 changes according to the movement of the pad 70. The pad is installed in the inside portion 32, thereby preventing the inconvenience of additionally carrying the pad 70. The user's palm or finger may be used to easily operate pad 70. In this regard, the click button 23 may be installed in the key input device 21 and/or the main body 20 in view of the user's convenience.

The inside portion 32 may include a position sensor 40 in an exterior circumferential surface thereof. The position sensor 40 allows the position of the mouse pointer to be located on the boundary of the display 10 when the inside portion 32 contacts the pad 70. When the user powers off the information processing apparatus 100, in particular, a notebook computer and then powers on the information processing apparatus 100, if the position sensor 40 and the pad 70 contact each other, the mouse pointer is positioned on the display 10 corresponding to the position of the position sensor 40.

In this regard, a plurality of position sensors 40 may be formed in the exterior circumferential surface of the inside portion 32 so that the mouse pointer corresponding to the position of the position sensor 40 is positioned on the boundary of the display 10. The position of the mouse pointer of the display 10 is previously established in a controller of the main body 20 according to the position of the position sensor 40 and the position of the mouse pointer is disposed to correspond to the previously established position of the mouse pointer.

Meanwhile, the sensing unit 60 may be an optical sensor including a light emitting sensor and a light receiving sensor for detecting the movement of the pad 70. The optical sensor is the same type of sensor that is installed inside the main body 20 and detects an up and down and left and right movement of the pad 70. That is, various types and shapes of optical sensors for detecting the movement of the pad 70 may be installed by using the light emitting sensor and the light receiving sensor.

The operation of the information processing apparatus of the present invention will now be described.

Referring to FIGS. 2B through 3B, the information processing apparatus 100 of the present invention, in particular, the notebook computer 100, includes the sensing unit 60 that detects a user's operation so as to adjust the position of the mouse pointer on the display 10 and is formed in one side of the main body 20. The sensing unit 60 includes the pad 70 which is disposed in the upper side of the sensing unit 60 and is movable so as to change the position of the mouse pointer.

If the user moves the pad 70 from the upper side of the sensing unit 60 up and down and left and right, the sensing unit 60 detects the movement of the pad 70 and displays the mouse pointer on the display 10 through the controller included in the main body 20.

In this regard, the pad 70 that is simply disposed on the sensing unit 60 moves by the user. Alternatively, groove portion 30 including the inside portion 32 which has a space where the pad 70 is movable is formed in the upper side of the sensing unit 60 and the pad 70 is inserted into the inside portion 32 and moves up and down and left and right.

The notebook computer 100 may include the position adjustment button 22 so as to adjust the position of the mouse pointer on the display 10. When a center of the pad 70 is disposed in the upper side of the sensing unit 60, the position adjustment button 22 allows the mouse pointer on the display 10 to be positioned in the center of the pad 70. When the notebook computer 100 is used after being booted by using the position adjustment button 22, an initial position of the mouse pointer may be established.

At least one of the key input device 21 and the main body 20 includes the click button 23 and the scroll member 24, in particular, a scroll wheel, having a general mouse function, thereby increasing the user's convenience.

Meanwhile, when the pad 70 is inserted into the inside portion 32, since the position of the mouse pointer may be changed according to the power on/off of the notebook computer 100, the plurality of the position sensors 40 are installed in the exterior circumferential surface of the inside portion 32 so that the mouse pointer is positioned on the display 10 corresponding to positions of the position sensors 40 when the pad 70 contacts the position sensors 40.

The information processing apparatus 100 makes it possible to easily adjust the position of the mouse pointer on the display 10 and prevents the user from having to carry an additional external mouse.

What is claimed is:

1. An information processing apparatus comprising:
a main body including a key input device;
a sensing unit installed in one side of the key input device and detecting a user's operation to adjust a position of a mouse pointer on a display; and
a pad disposed on the upper side of a sensing unit and movable to change the position of the mouse pointer on the display.

2. The information processing apparatus of claim 1, wherein at least one of the key input device and the main body comprises a position adjustment button that allows the mouse pointer to be positioned on the center of the display when the center portion of the pad is positioned in the upper side of the sensing unit.

3. The information processing apparatus of claim 1, wherein at least one of the key input device and the main body comprises a click button that is used to designate the position of the mouse pointer.

4. The information processing apparatus of claim 1, wherein at least one of the key input device and the main body comprises a scroll member that is used to change a position in an information document that is being read.

5. The information processing apparatus of claim 1, wherein the sensing unit is integrally installed in the main body.

6. The information processing apparatus of claim 5, wherein the main body comprises a groove portion in the upper side of the sensing unit, the groove portion comprises an entrance portion contact the exterior and an inside portion formed to be greater than the radius of the entrance portion and curved inside the groove portion, and the pad is inserted into the inside portion and is movably installed.

7. The information processing apparatus of claim 6, wherein the inside portion comprises a position sensor that allows the mouse pointer to be positioned on the boundary of the display when the pad contacts the exterior circumferential surface of the inside portion.

8. The information processing apparatus of claim 7, wherein a plurality of the position sensors are installed in the exterior circumferential surface of the inside portion so that the mouse pointer is positioned on the boundary of the display corresponding to the position of the position sensor.

9. The information processing apparatus of any one of claims 1 through 8, wherein the sensing unit comprises an optical sensor including a light emitting sensor and a light receiving sensor for detecting the movement of the pad.
